(19) United States
(12) Patent Application Publication
(10) Pub. No.: US 2011/0270666 A1
(43) Pub. Date: Nov. 3, 2011

(54) System and Method for Providing Financial Incentives and Discentives Based on a Consumer Activity

(76) Inventors: Thomas R. Welsh, San Francisco, CA (US); Satyam Priyadarshy, Herndon, VA (US)

(21) Appl. No.: 13/098,755

(22) Filed: May 2, 2011

Related U.S. Application Data
(60) Provisional application No. 61/330,164, filed on Apr. 30, 2010.

(51) Int. Cl. G06Q 30/00

(52) U.S. Cl. 705/14.34

(57) ABSTRACT

A system and method for providing financial incentives and disincentives to a consumer based on a consumer activity. A record related to the consumer activity is received by a Computer Server and stored in a Consumer Database. The Consumer Database includes historical consumer activity associated with the registered consumer. The historical consumer activity is transmitted to at least one registered marketing entity. Based on the historical consumer activity, the registered marketing entity provides a financial incentive and/or disincentive which is processed and automatically applied to a qualified registered consumer.

### CROSS-REFERENCE TO RELATED APPLICATION

This application claims the benefit of U.S. Provisional Patent Application No. 61/330,164, titled, “Enformed”, filed Apr. 30, 2010, the entire disclosure of which is incorporated herein by reference.

### FIELD OF THE INVENTION

The present invention relates generally to a method and system for providing financial incentives and disincentives based on consumer activity, and more particularly to building a collaborative database of highly structured consumer activity data in order to apply the financial incentives and disincentives to the activities of a consumer.

### BACKGROUND OF THE INVENTION

The purpose of a marketplace is not only to serve as a place for buyers and sellers to transact, but also to serve as a medium of information exchange. In a “free market” system, individual buyers and sellers self-organize and exchange information about themselves and about their goods. The actual exchange of goods, as any futures trader will attest, is not always necessary. In an ideal free market, all parties exchange information freely. However, these ideal free markets do not exist in the real world as all real-world markets have frictions which limit information-sharing efficiency. These frictions arise because information itself cannot be universally accessible, communicable, and interpretable to all market participants simultaneously. The nature of limited supply and uneven distribution of information gives the information itself value. Since information is limited and unevenly distributed, individuals with more information, acting in their own self-interest, can exploit those who have less information, and resulting in the withdrawal of some market participants and a potential collapse of the market. In order to combat this tendency, successful markets require participants to adhere to rules governing the sharing of information so that inefficiencies arising from information asymmetries will be limited.

The conventional consumer marketplace is one such market which is very inefficient. Consumers buy (and sell) many goods, but their participation in the information-sharing aspects of the marketplace is generally limited to when they purchase a product and communicate that their willingness to pay is at least equal to the purchase price of a given item. In most cases, this information is often not captured, it deteriorates, or it is lost on an individual level. Retailers and manufacturers spend billions annually on advertising and promotion of their products, but because much of this spending is lavished on consumers who are unlikely purchasers, a good portion of their investment is effectively wasted. In order to improve the efficiency of promotional investment, retailers and manufacturers spend billions more on research and information systems (in particular, the construction, maintenance, and security of proprietary Consumer Databases) which help identify which those individual shoppers that are most likely to become purchasers. Since this information is very valuable, retailers and manufacturers act in their own self-interest to hoard consumer information in their own propriety, redundant information silos.

In practice, in a conventional information marketplace of three constituencies (i.e., consumers, retailers, and manufacturers), the consumers as a class are typically the least empowered and most often exploited because they typically have the least amount of information and do not have a means to collect or monetize information like retailers and manufacturers do. Furthermore, while retailers and manufacturers often coax consumers to share more information through the use of incentives (including loyalty programs, discounts, and free services), retailers and manufacturers give as few incentives (and as little value) as possible to consumers for their information, as would be expected in a distributive bargaining scenario. Thus, the market reaches a suboptimal equilibrium where retailers and manufacturers compete against each other to extract as much information from consumers at the lowest possible cost. Since most of the additional benefits go to the retailers and manufacturers, consumers have few meaningful short-term incentives to cooperate with retailers and manufacturers on the collection and sharing of more information and on the ultimate removal of frictions from the consumer information marketplace. In other words, markets arranged in this way rely on consumers to contribute information to the marketplace more out of goodwill than out of self-interest.

Thus, there is a need in the art to overcome the deficiencies of the conventional market systems by allowing the consumers to participate in the market by enabling the collection, aggregation and control of pools of consumer related information in order to trade such information in the marketplace. Therefore, there is a need for a system and a method to provide financial incentives and/or disincentives to consumers based on their own active participation in the marketplace.

### SUMMARY OF THE INVENTION

In one embodiment, the present invention provides a computer-implemented system and method for providing at least one financial incentive to a consumer. The system and method include receiving from at least one of a registered retail entity or a registered consumer a record relating to a purchase made by the registered consumer and storing the record in a consumer database including a consumer profile associated with the registered consumer. The consumer profile includes one or more forms of identification data associated with the registered consumer and historical purchase data. The system and method also includes providing to at least one registered marketing entity the historical purchase data without disclosing the identification data associated with the registered consumer and receiving from the at least one registered marketing entity the at least one financial incentive based on the historical purchase data. The system and method further includes processing the at least one financial incentive to identify the registered consumer eligible for the at least one financial incentive, reviewing the historical purchase data in the consumer profile to determine if the identified consumer is qualified to receive the financial incentive, and automatically applying the financial incentive to the qualified registered consumer.

In another embodiment, the present invention provides a computer-implemented system and method for providing at least one of a financial incentive or a financial disincentive to the consumer. The system and the method includes receiving from at least one of a registered retail entity or a registered consumer, a record relating to a consumer activity by the registered consumer and storing the record in a consumer database comprising a consumer profile associated with the registered consumer. The consumer profile includes one or more forms of identification data associated with the registered consumer and historical consumer activity data. The system and method also includes providing to at least one registered marketing entity the historical consumer activity data without disclosing the identification data associated with the registered consumer and receiving from the at least one registered marketing entity, the at least one of a financial incentive or the financial disincentive based on the historical consumer activity. The system and method further includes processing the at least one financial incentive or the financial disincentive to identify the registered consumer eligible for the at least one of the financial incentive or the financial disincentive, reviewing the historical consumer activity data in the consumer profile to determine if the identified consumer is qualified to receive one of the financial incentive or the financial disincentive and automatically applying one of the financial incentive or the financial disincentive to the qualified registered consumer.

### BRIEF DESCRIPTION OF THE DRAWINGS

The present invention will be more readily understood from the detailed description of exemplary embodiments presented below considered in conjunction with the attached drawings, of which:

FIG. 1 is a block diagram illustrating components of an exemplary financial incentive/disincentive system architecture, according to one or more embodiments of the present invention; and

FIG. 2 is a flow chart illustrating steps of an exemplary process for providing financial incentives and/or disincentives, according to one or more embodiments of the present invention.

### DETAILED DESCRIPTION OF THE INVENTION

The present invention relates to a method and a system for providing financial incentives and disincentives based on consumer activity. The system functions to receive the consumer activity from one or more retail entities and/or one or more marketing entities and store the consumer activity in a consumer profile and further transmit the historical consumer activity to one or more marketing entities. The system also functions to process the financial incentives and disincentives received from one or more of the marketing entities and apply the processed financial incentives and disincentives to the consumers. Such processing includes filtering the incentives and disincentives, ranking the incentives and disincentives, matching the incentives and disincentives with the registered consumers and automatically applying the incentives and disincentives to the matched consumers. The system may preferably track information for the purpose of charging a fee to the registered marketing entities for processing and/or applying the financial incentive or disincentive.

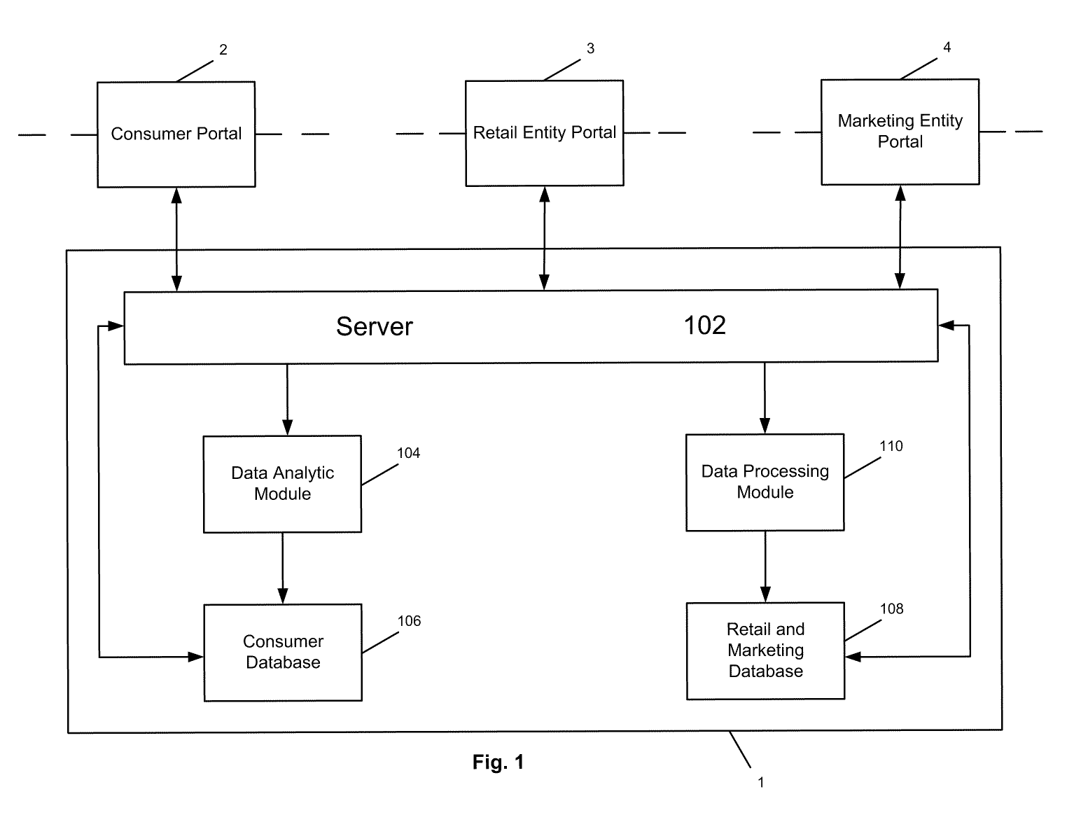

The system is herein referred to as the “Financial Incentive-Disincentive System” or FIDS 1. As used herein, the term “financial incentive” is intended to include, but is not limited to, cash, a check, an electronic monetary deposit, a coupon, a rebate or other like expression having a monetary or financial value. And used herein, the term “financial disincentive” is intended to include, but not is limited to, a price-setting based on a condition of determining a price which may require the examination of previous consumer activity. For example, as a condition of selling a mobile phone, a retail entity may require that the consumer use the FIDS 1 to demonstrate that they have already bought a service package. The retail entity may charge $200 for the phone if the consumer already bought a package from Provider A, and the retail entity may charge $300 for the phone if they already bought a package from Provider B. Thus, the retail entity gives a $100 “financial disincentive” to consumers who are locked into a contract with Provider B. Another example is a travel agent who quotes a price on a vacation package only if the consumer agrees to share their prior purchase history. If the travel agent quotes a price of $750 to consumers who have previously received an incentive from the agent before, and $500 to consumers who have not previously received an incentive from the agent, then there is a $250 “financial disincentive” to consumers who have previously received another incentive. FIG. 1 depicts the FIDS 1 according to embodiments of the present invention. The FIDS 1 is a computer-based system, accessible by one or more “users” (via user devices 2, 3, 4) associated with one or more consumer entities, retail entities and marketing entities who have been granted the necessary authorization and access to the FIDS 1. The term “consumer” or “consumer entity” is intended to include any person, household, group, or organization that purchases an item, a commodity or a service. The term “retail entity” is intended to include any person, household, group or organization that operates a retail establishment that sells goods and/or services to consumers. The term “marketing entity’ is intended to include any person, household, group or organization that manufactures, markets and/or sells goods and/or services to consumer entities and/or retail entities. It is noted that the marketing entity may function as a retail entity and vice versa. The term “user device” is intended to include, but is not limited to, any computer device, such as, for example, a cell phone, a tablet (e.g. Apple iPad™), Smartphone, a personal digital assistant, a desktop computer, a personal computer, a laptop, a netbook, a tablet or any other device, that is configured to communicatively connect to and access the FIDS 1. The term “computer” is intended to include any data processing device, such as a desktop computer, a laptop computer, a mainframe computer, a personal digital assistant, a Server, a netbook, a tablet, a handheld device or any other device configured to process data.

According to an embodiment of the present invention, the FIDS 1 is configured to build a highly efficient and collaborative consumer information marketplace of consumer activity in order to provide the incentives and disincentives to the consumers. As shown in FIG. 1, according to an embodiment of the present invention the FIDS 1 comprises a Server 102, a Data Analytic Module 104, a Consumer Database 106, Retail and Marketing Database 108, and a Data Processing Module 110. The aforementioned components of the FIDS 1 represent computer-implemented hardware and software modules (referred to “computer modules”) configured to perform the functions described in detail below. The term “computer module” is intended to include, but is not limited to, one or more computers configured to execute one or more software programs configured to perform one or more functions. One having ordinary skill in the art will appreciate that the components of the FIDS 1 may be implemented on one or more communicatively connected computers. The term “communicatively connected” is intended to include, but is not limited to, any type of connection, whether wired or wireless, in which data may be communicated, including, for example, a connection between devices and/or programs within a single computer or between devices and/or programs on separate computers. According to an embodiment of the present invention, the components of the FIDS 1 may each be a computer module particularly configured to perform the function associated with the respective components as described below.

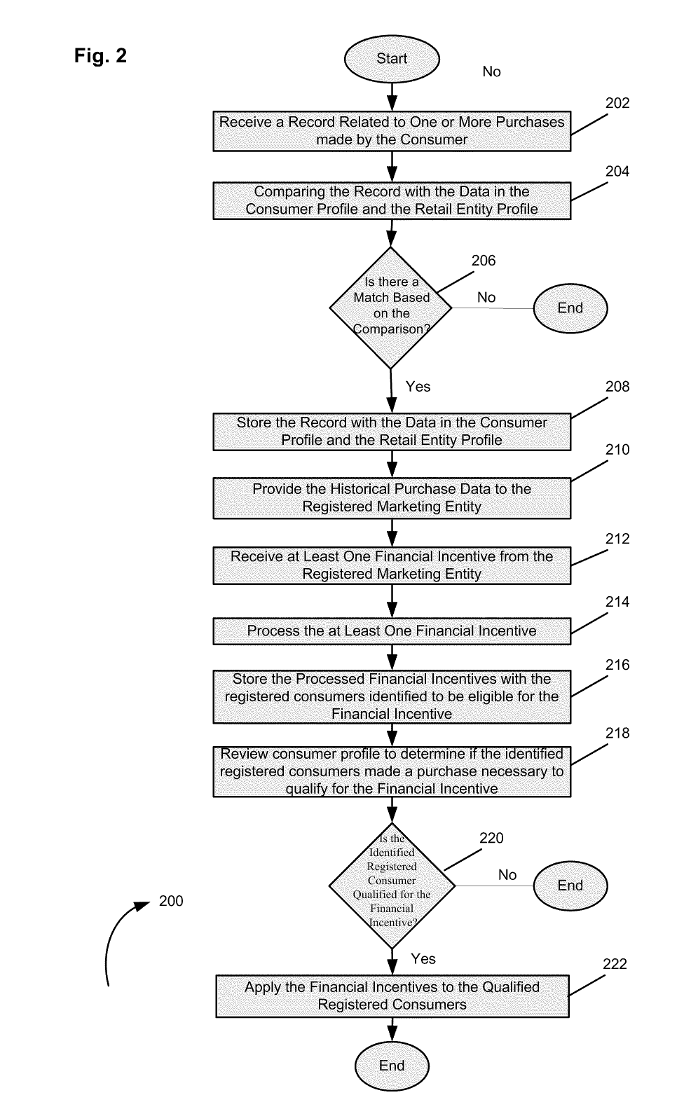

The features and functionality of the FIDS 1 and its components are described in detail in connection with the system diagram of FIG. 1 and the process flow diagram presented in FIG. 2. With reference to FIG. 1, the Server 102, preferably a web Server, presents a user friendly application to a consumer via a Consumer Portal 2 to enable the consumer to enroll/register with the FIDS 1 and create/update a consumer profile to be stored in the Consumer Database 106. The consumer profile contains one or more forms of identification data associated with the registered consumer, which is preferably used to identify the consumer by the Data Analytic Module 104. The consumer identification data includes, but is not limited to, one or more of a consumer's name, age, sex, phone number, social security number, home address, e-mail address, credit care, digital identification card, visual identification card, or other suitable identifying information. The consumer uses one or more of the identification data when attempting, not attempting, performing, not performing, completing or not completing a consumer activity. Such consumer activity includes but is not limited to, undertaking a transaction/purchase, or viewing or communicating information. Some examples include viewing a list of offers, viewing an advertisement, browsing a web page, sending an email or other digital message, interacting with a social network, interacting with an advertisement, recording a location with a monitoring device or other activities.

The Server 102 of FIG. 1 also presents a user friendly application to a retail entity via the Retail Entity Portal 3 to enable the retail entity to enroll/register with the FIDS 1 and create/update retail entity profile to be stored in the Retail and Marketing Database 108. The retail entity profile preferably contains one or more forms of identification data associated with the retail entity and listing of the goods and/or services provided by the retail entity. Similarly, the Server 102 also presents a user friendly application to a marketing entity of the Marketing Entity Portal 4 to enable the marketing entity to enroll/register with the FIDS 1 and further create/update a marketing profile to be stored in the Retail and Marketing Database 108. The marketing profile preferably contains one or more forms of identification data associated with the marketing entity and a listing of the goods and/or services provided by the marketing entity.

The Server 102 also presents a user friendly application configured to receive the consumer activity data from one or more Retail Entity Portals 3. The consumer activity data is stored in the consumer profile associated with the consumer identification data in the Consumer Database 106. The consumer profile includes consumer historical activity data comprising consumer browsing history data, consumer communication history data and/or consumer historical purchase data. The consumer browsing history data includes, but is not limited to, a record history of web pages visited by the consumer associated with the identifier data and one or more registered retail and/or marketing entities associated with the visited web pages. The consumer browsing history data may also include a record history of products and/or services viewed by the consumer associated with the identifier data and one more registered retail and/or marketing entities associated with the viewed products/and or services. The consumer communication history data includes a record history of products and/or services communicated by the consumer via retail entity and/or marketing entity with the identifier data and one or more registered retail and/or marketing entities associated with the communicated products and/or services. Such communication may include, but is not limited to, inquiry regarding price, warranty and/or other information related to the products and/or services. The consumer historical purchase data includes a history of purchases associated with the identifier data and one or more registered retail and/or marketing entities associated with the purchases.

The Server 102 periodically accesses the stored historical consumer activity data from the Consumer Database 106 to send to one or more Marketing Entity Portals 4. The Server 102 further functions to receive financial incentives and disincentives from the Marketing Entity Portal 4. The Data Processing Module 110 functions to process the financial incentives and disincentives, which are later stored in the Consumer Database 106. The Data Analytic Module 104 further functions to review the consumer profile for the consumer's eligibility of the financial incentive and/or disincentive. The financial incentives and/or disincentives are automatically applied by the Server 102 to the eligible registered consumer entities via the Consumer Portal 2.

FIG. 2 illustrates a method 200 for providing financial incentives and disincentives based on consumer activity. Method 200 is described herein in connection with an example where the consumer activity is a purchase made by the consumer, consumer historical purchase data is sent to the registered marketing entity and a financial incentive is received from the registered marketing entity based on the consumer historical purchase data. One having ordinary skill in the art will appreciate that other types of consumer activities (as described above) may preferably be used in connection with the method 200. Also, one having ordinary skill in the art will appreciate that other data, such as consumer historical browsing data and/or consumer historical communication data as described above may preferably be sent to the registered marketing entity. Further, one having ordinary skill in the art will appreciate that a financial disincentive may be received from the registered marketing entity based on one or more of the consumer historical purchase data, consumer historical browsing data and/or consumer historical communication data.

Beginning with step 202, a record relating to one or more purchases made by a consumer at a first period is received by the FIDS 1 via the Server 102. This record may preferably be received from one of a Consumer Portal 2, a Retail Entity Portal 3 or a Marketing Entity Portal 4. The record includes the identifier data associated with the consumer, one or more purchases made by the consumer and at least one retail entity associated with the one or more purchases. The record may preferably be a digital record. Then, using the Data Analytic Module 104, at step 204 the record data including at least the identifier data associated with the consumer is compared with the consumer profile in the Consumer Database 106 and the record data including the retail entity associated with the one or more purchases is compared with the retail entity profile in the Retail and Marketing Database 108. Such comparing is performed by an algorithm that selects at least one purchase from the record data, and extracts a specific value from it that might be a unique to consumer identifier data. This value is then tested against all of the identifier data associated with the registered consumers in the consumer profile stored in the Consumer Database 106. Similarly, the algorithm selects the purchase from the record data and extracts a specific value from it that might be unique to a retail identifier data. This value is then tested against all of the identifier data associated with the registered retail entities in the retail entity profile stored in the Retail and Marketing Database 108. Then, at step 206, it is determined whether there is a match between the consumer associated with the record with the registered consumer in a consumer profile stored in the Consumer Database 106 and if there is match between the retail entity associated with the record with the registered retail entity stored in a retail entity profile stored in the Retail and Marketing Entity Database 108. If at step 206, if it is determined that there is no match of records for both the consumer and the retail entity, then that record may or not be used in this system and process ends for that record. In such a case scenario when the consumer or the retailer (or the item purchased) cannot be accurately identified, then the information is considered incomplete. So, depending on the nature of the information's completeness, the Data Analytic Module 104 may or may not store it in the consumer profile. For example, if a “retailer” such as a restaurant sends data that a particular consumer spent $20 on a particular day, but does not specify what the consumer ordered or what the consumer ate, the information including the consumer spent a total of $20 in the restaurant may or may not be stored in the consumer profile. If at step 206, it is determined that both the consumer and the retail entity record match, then the record is stored in the historical purchase data of the consumer profile associated with the registered consumer in the Consumer Database 106, at step 208.

At step 210, the historical purchase data is sent to at least one registered Marketing Entity Portal 4. It is noted that the historical purchase data sent to the registered Marketing Entity Portal 4 according to an embodiment, preferably excludes the identifier data of the consumer (i.e., the consumer remains anonymous). However, in the alternate embodiment, the identifier data of the consumer with the historical purchase data may be sent to the registered marketing entity. At step 212, at least one financial incentive is received by the FIDS 1 via the Server 102 from at least one registered Marketing Entity 4 based on the historical purchase data. Next, at step 214, at least one financial incentive is processed by the Data Processing Module 110. In one embodiment, the data processing of the financial incentive includes filtering the incentives based on a specific criteria set by the marketing entity that limit the eligibility of consumers for the incentive to just a subset of the consumer population who have captured specific proofs of behavior in their historical purchase data profiles. The incentives are preferably filtered further by the Data Processing Module 110 by limiting the eligibility of the offer to a random sampling of this subset. For example, a marketing entity can restrict the offering of a financial incentive to a random sample of preferably 25% of the consumer population that has bought a specific product or combination of products such as a particular brand of cereal in the last 3 months and has not bought another brand. In another example, a marketing entity may offer the financial incentive to those consumers who have been previously offered the financial incentives from the marketing entity or have utilized the previously offered financial incentives. The Data Analytic Module 104 functions to input variables to query the Consumer Database 104 and adjust the size and characteristics of a target pool of consumers based the specific criteria defined by the marketing entity. In other words, by changing variables that determine the eligibility of consumers based on the information captured in their consumer purchasing histories, marketing entities can define how few or how many consumers would be eligible for a given incentive.

In another embodiment, the data processing of the financial incentives includes ranking the financial incentives based on the likelihood of redemption and the value of the incentive. So, for example, if the expected value of an incentive is equal to the expected redemption rate of the incentive multiplied by the value of the incentive, it is possible to rank the financial incentives according to their expected values: given all of the purchases recorded in all purchase histories, a multivariable regression is preferably run by the Data Processing Module 110 which determines the likelihood of the fact that presence of a particular item will correlate to the purchase of another item at some point in the future. Probabilities of a particular item purchase during the next shopping trip may preferably be assigned. These probabilities, multiplied by the value of the incentive, convey the likelihood that a consumer will earn the incentive on their next shopping trip. Such incentives may be ranked by this expected value when displaying multiple offers to the consumers.

Then, at step 216, processed financial incentives are stored in the consumer profile of the Consumer Database 106 with the associated registered consumers identified to be eligible for the financial incentive. The identified registered consumers, including the corresponding processed financial incentives, may preferably be displayed to the associated marketing entity. At a later time, using the Data Analytic Module 104, at step 218, the historical purchase data of the consumer profiles of the identified registered consumers eligible for the financial incentive are reviewed and tested to determine if they are qualified to receive the financial incentive. In other words, it is determined whether the consumers collected the information in their profile necessary to redeem the incentive for which they were previously qualified or eligible. So, for example, the Data Analytic Module 104 checks to see if the identified consumer made a purchase that would qualify the consumer for the financial incentive. If it is determined at step 220 that the identified consumer did collect such information such as made the purchase, then at step 222, the stored financial incentive is automatically applied to each of the qualified registered consumers. In one embodiment, the financial incentive is applied with a subsequent consumer activity and/or purchase via the identifier data associated with the registered consumer. Such financial incentive is preferably applied as an automatic rebate at a point of sale associated with the one or more registered retail entities. In another embodiment, such financial incentive is preferably applied as a cash value sent directly to the registered consumer. Alternatively, the financial incentive is preferably applied as an automatic deposit to a consumer's bank account. However, if at step 220, it is determined that the consumer did not collect the information necessary to redeem the financial incentive, then the financial incentive is not applied to the consumer and the process ends for that consumer. Furthermore, by offering a financial incentive to a randomized subset of consumers with specific histories, and providing a different incentive (or note at all) to a similar subset of consumers with similar histories, marketing entities can measure the actual performance of the incentive in statistical isolation.

The FIDS 1 provides for a more efficient consumer information marketplace by providing a vehicle by which a consumer can collect and aggregate his/her own pool of information and trade that information in the marketplace. FIDS 1 function to collect data in the Server from Retail Entity Portals, organize it into highly structured, easily searchable pool of consumer profiles that are curated by consumers through the Consumer Portal, and then make this pool of consumer profiles easily accessible through the Marketing Entity Portal. Because consumers are the collectors and curators of their own data, and because marketing entities can communicate and pass incentives directly to consumers based on this data, consumers can freely “shop” their data to multiple marketing entities. As a result, consumers can seek to maximize their data by trading it to the highest bidder (biggest incentive provider). For this reason, FIDS more strongly incentivizes consumers to participate than other information markets. The FIDS 1 also provides other advantages. First, by allowing consumers to become keepers of their own data, they can maintain greater control over their privacy and how their personal data is used. Second, FIDS 1 shifts the burdens of repeated incentive enrollment and opt-in from consumers to the marketing entities. In FIDS 1, consumers simply collect their information in one profile, while marketing entities must enroll their promotions and promotional programs with individual consumers

Although embodiments of the present application described above disclose collecting and storing consumer activity related to consumer personal purchasing histories, one having ordinary skill in the art will appreciate that the method/system may incorporate any type of information collected based on consumer activity, including, but not limited to, biographical, social, behavioral, intellectual, emotional, and factual information. According to one embodiment, the FIDS 1 may be configured to receive an alert on a product recall from the registered retail entities and marketing entities and to inform of the product recall to the registered consumers. According to another embodiment of the present invention, the FIDS 1 is configured to offer a service to registered retail entities and marketing entities that may include the processing of cash as a financial incentive through the FIDS 1 to any other party in the system, and preferably charge a fee to users of the service. In another additional embodiment according of the present invention, the FIDS 1 is configured to provide a platform by which advertisers can show or rank or charge for advertisements that are targeted based on consumer historical purchase data. So, FIDS 1 functions preferably as third party agent that allows advertisers to view the historical purchasing information and send advertisements. Alternatively, advertisers may be charged a fee to get access to information stored in their consumer profiles so that advertisers can determine which advertisements to display to the consumers.

The FIDS 1 is configured to receive a verification of a purchase or other action verification by a consumer from a third party entity. Such action by a consumer may include, but not limited to, receiving an offer, viewing an ad, or accumulating a social network connection, etc. Further, FIDS 1 is configured to allow marketing entities and retail entities to configure, establish and manage consumer test panels that were selected based upon the aggregated third-party verifiable information in the FIDS 1.

The FIDS 1 is configured to offer for sale or sell individual consumer information (in summary or individual format) to another party on behalf of consumers and share revenues with consumers (or other parties). The FIDS 1 is configured to provide an escrow service for two or more additional parties. Further, FIDS 1 is configured to include the FIDS 1 to verify the shopper histories for third parties who may want to use the information as a means of identity verification.

It is to be understood that the exemplary embodiments are merely illustrative of the invention and that many variations of the above-described embodiments may be devised by one skilled in the art without departing from the scope of the invention. It is therefore intended that all such variations be included within the scope of the following claims and their equivalents.

1. A computer-implemented method for providing at least one financial incentive to a consumer, the method comprising:
receiving from at least one of a registered retail entity or a registered consumer, a record relating to a purchase made by the registered consumer;
storing the record in a consumer database comprising a consumer profile associated with the registered consumer, wherein the consumer profile comprise one or more forms of identification data associated with the registered consumer and historical purchase data;
providing to at least one registered marketing entity the historical purchase data without disclosing the identification data associated with the registered consumer;
receiving from the at least one registered marketing entity, the at least one financial incentive based on the historical purchase data;
processing the at least one financial incentive to identify the registered consumer eligible for the at least one financial incentive;
reviewing the historical purchase data in the consumer profile to determine if the identified consumer is qualified to receive the financial incentive; and
automatically applying the financial incentive to the qualified registered consumer.

2. The computer-implemented method of claim 1 wherein the record comprises identifier data associated with the registered consumer, information associated with one or more purchases made by the registered consumer, and the at least one registered retail entity associated with the one or more purchases.

3. The computer-implemented method of claim 2 wherein the historical purchase data comprises a history of purchases associated with the identification data and one or more registered retail entities associated with the purchases.

4. The computer-implemented method of claim 1 further comprising storing the processed financial incentives with the registered consumers identified to be eligible for the financial incentive.

5. The computer-implemented method of claim 1 further comprising comparing the identifier data in the record to the one or more forms of identification data associated with the registered consumer stored in the consumer profile.

6. The computer-implemented method of claim 1 further comprising comparing, the record to a retail entity profile, wherein the retail entity profile comprises one or more forms of identification data associated with the registered retail entity.

7. The computer-implemented method of claim 1 wherein the processing comprises filtering the at least one financial incentive based on the stored consumer profile and a specific criteria provided by the at least one registered marketing entity.

8. The computer-implemented method of claim 1 wherein said processing further comprising ranking the at least one financial incentives based on the stored consumer profile, wherein said stored consumer profile further comprises a predicted redemption of the financial incentive by the registered consumer.

9. The computer-implemented method of claim 1 wherein the financial incentive comprises a cash value send to the registered consumer.

10. The computer-implemented method of claim 1 wherein the financial incentive comprises a rebate on the subsequent purchase made by the registered consumer with the one or more registered retail entities.

11. The computer-implemented method of claim 1 wherein the record is a digital record of the purchase made by the registered consumer.

12. The computer-implemented method of claim 1 further comprising charging a fee based on the financial incentive to at least one of the registered consumers, the registered retail entities and the registered marketing entities.

13. A computer-implemented system for providing at least one financial incentive to a consumer, the system comprising:
a consumer database comprising a consumer profile associated with a registered consumer, wherein the consumer profile comprises one or more forms of identification data associated with the registered consumer and historical purchase data;
a retail and marketing database comprising retail entity profile associated with at least one registered retail entity;
a computer server, coupled to the consumer database and the retail and marketing database, the computer server configured to perform the steps of:
receiving from at least one of a registered retail entity or a registered consumer, a record relating to a purchase made by the registered consumer;
storing the record in the consumer database;
providing to at least one registered marketing entity the historical purchase data without disclosing the identification data associated with the registered consumer;
receiving from the at least one registered marketing entity, the at least one financial incentive based on the historical purchase data;
processing the at least one financial incentive to identify the registered consumer eligible for the at least one financial incentive;
reviewing the historical purchase data in the consumer profile to determine if the identified consumer is qualified to receive the financial incentive; and
automatically applying the financial incentive to the qualified registered consumer.

14. A computer-implemented method for providing at least one of a financial incentive or a financial disincentive to the consumer, the method comprising:
receiving from at least one of a registered retail entity or a registered consumer, a record relating to a consumer activity by the registered consumer;
storing the record in a consumer database comprising a consumer profile associated with the registered consumer, wherein the consumer profile comprises one or more forms of identification data associated with the registered consumer and historical consumer activity data;
providing to at least one registered marketing entity the historical consumer activity data without disclosing the identification data associated with the registered consumer;
receiving from the at least one registered marketing entity, the at least one of a financial incentive or the financial disincentive based on the historical consumer activity;
processing the at least one financial incentive or the financial disincentive to identify the registered consumer eligible for the at least one of the financial incentive or the financial disincentive;
reviewing the historical consumer activity data in the consumer profile to determine if the identified consumer is qualified to receive one of the financial incentive or the financial disincentive; and
automatically applying one of the financial incentive or the financial disincentive to the qualified registered consumer.

15. A computer-implemented system for providing at least one of a financial incentive or a financial disincentive, the system comprising:
a consumer database comprising consumer profile associated with a registered consumer, wherein the consumer profile comprises one or more forms of identification data associated with the registered consumer and historical consumer activity data;
a retail and marketing database comprising retail entity profile associated with at least one registered retail entity;
a computer server, coupled to the consumer database and the retail and marketing database, the computer server configured to perform the steps of:
receiving from at least one of a registered retail entity or a registered consumer, a record relating to a consumer activity by the registered consumer;
storing the record in a consumer database;
providing to at least one registered marketing entity the historical consumer activity data without disclosing the identification data associated with the registered consumer;
receiving from the at least one registered marketing entity, the at least one of a financial incentive or the financial disincentive based on the historical consumer activity;
processing the at least one of the financial incentive or the financial disincentive to identify the registered consumer eligible for the at least one of the financial incentive or the financial disincentive;
reviewing the historical consumer activity data in the consumer profile to determine if the identified consumer is qualified to receive one of the financial incentive or the financial disincentive; and
automatically applying one of the financial incentive or the financial disincentive to the qualified registered consumer.
